(19) United States
(12) Patent Application Publication
(10) Pub. No.: US 2010/0190561 A1
(43) Pub. Date: Jul. 29, 2010

(54) Drilling motor coupling

(75) Inventors: Thomas E. Falgout, JR., Lafayette, LA (US); Chad M. Daigle, Lafayette, LA (US)

Correspondence Address: DURIO, MCGOFFIN, STAGG & ACKERMAN, P.O. BOX 51308, LAFAYETTE, LA, 70505, US

(73) Assignee: TOMAHAWK DOWNHOLE LLC, Lafayette, LA (US)

(21) Appl. No.: 12/321,817

(22) Filed: Jan. 26, 2009

(51) Int. Cl. F16D 3/16

(52) U.S. Cl. 464/157

(57) ABSTRACT

A flexible drilling motor drive shaft coupling has two torque transmitting portions spaced apart axially, preferably, by a compression unit that is secured to one portion by a tension link and entrapped within the other portion. The tension link is, preferably, a cap screw extending along the axis of rotation of the coupling.

### BACKGROUND

The U.S. Pat. No. 5,205,789, issued Apr. 27, 1993 is incorporated in this application by reference herein.

In the drilling industry, some down hole mud powered drilling motors require flexible shafts to connect the power producing rotors to stable output shafts. Limited radial space limits the shafts to sizes that are challenged by the output torque of the motor rotors. The flexible couplings have been a source of life limiting factors for such motors since their introduction in the drilling activity.

In addition to coupling motor rotors to output shafts, flexible couplings are used between bearing supported output shaft members to allow the motor output shaft to function in bent motor bodies used in directional drilling activities.

A significant improvement in the motor couplings is represented by the U.S. Pat. No. 5,205,789, issued Apr. 27, 1993. It incorporated a three jaw, interdigitating, arrangement. It has been in use, with seals to confine lubricant within the coupling, and without seals if drilling mud had lubricating qualities. The present improvement adds elements to prevent separation of the lower end of the motor output shaft as a result of pulling hard on a stuck drill string.

A compression unit is used between the jaw carrying portions. The motor rotor normally, when drilling, tends to push the rotor out of the related stator and is held in place by way of the compression unit that delivers thrust loads to a robust bearing pack of the motor output shaft. The compression unit is designed to be secured in one portion and be axially trapped in the other portion to also carry some tension loads. As a secondary function it keeps the motor rotor from moving toward the top of the motor during handling and transport. The compression unit was secured in one portion by shear pins. The dependence on shear pins has been replaced by more rugged threaded fasteners as presented herein.

In some cases, the drill head becomes stuck in the formations being drilled and the drill string is pulled hard to recover the string. If the motor separates, some parts of the motor and the bit will be left in the well. That poses a very undesirable problem before drilling can continue. In motor shaft couplers that are held together with cross pins or set screws they may be sheared, allowing motor separation. A stronger coupling, in terms of resistance to motor part separation is needed. The present invention is directed to adding tension related strength to resist tension related separation in the motor-to-shaft coupling.

### SUMMARY OF THE INVENTION

A flexible motor coupling, preferably a jaw-type coupling with two interdigitating principal portions, has a compression unit that, preferably, includes a ball and socket articulating arrangement that carries compression loads that are transmitted through the coupling. The compression unit is secured in one portion of the coupling and is trapped in the other portion. The secured end is axially secured by a threaded fastener, preferably a cap screw, that extends axially through the portion in which the compression unit is secured.

These and other objects, advantages, and features of this invention will be apparent to those skilled in the art from a consideration of this specification, including the attached claims and appended drawings.

### BRIEF DESCRIPTION OF DRAWINGS

Exemplary drawings are provided to illustrate the points of novelty. They show only a selection of the many possible configurations of the coupling configurations that can be protected by the novel features.

FIG. 1 is a side elevation, mostly in cut-away, of the complete rotor to output shaft version with two couplings.

FIG. 2 is an enlarged view of the right end coupling of the assembly of FIG. 1, somewhat modified.

FIG. 3 is a side view of a section through the coupling structure of one form of prior art.

FIG. 4 is an enlarged, fragmented, view of an alternate configuration the coupling features.

FIG. 5 is a fragmented, side view, mostly in cut-away, of an alternate configuration of the coupling.

FIG. 6 is a section taken along line 6-6 of FIG. 7.

FIG. 7 is a side view of the mid-section of the preferred form of the coupling.

### DETAILED DESCRIPTION OF DRAWINGS

In the formal drawings, features that are well established in the art and do not bear upon points of novelty are omitted in the interest of descriptive clarity. Such omitted features may include threaded junctures, weld lines, sealing elements, pins and brazed junctures.

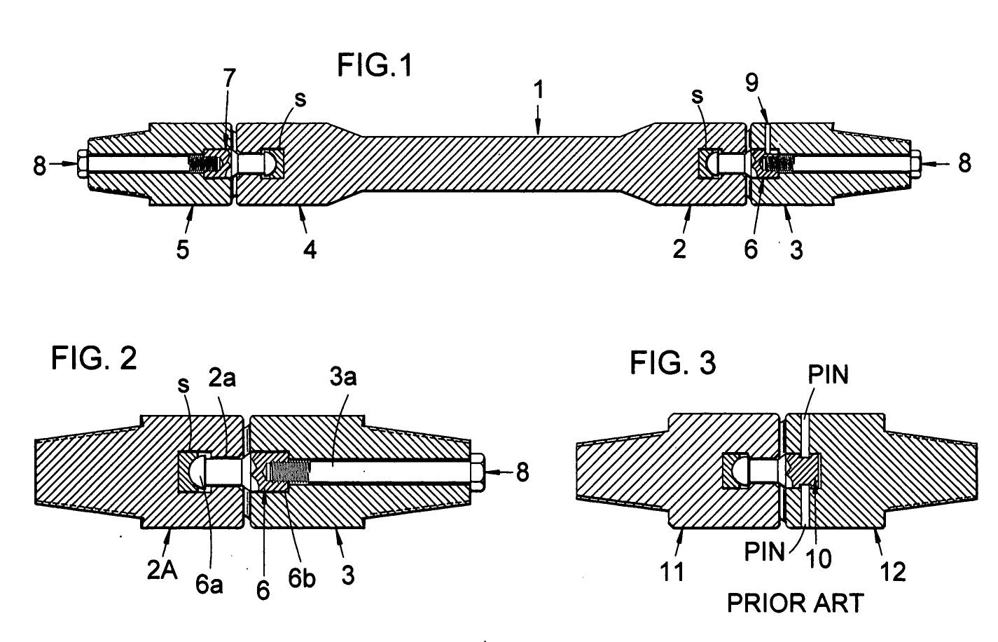

In the usual operational device, with positive displacement drilling motors the arrangement of FIG. 1 permits a motor rotor attached to portion 5 to orbit the extended centerline of portion 3. Portion 3 usually runs in an axis stable relationship to an output bearing pack that carries a drill head. The usual orbit of portion 5 is a small circle.

If the flexible arrangement of FIG. 1 is used with turbine-type drilling motors, the flexing is usually required to transmit torque when bent motor housings are used for directional drilling. In such cases, both portion 5 and portion 3 run on stable axes but the axes usually intersect at some small angle and only one of the two couplings shown may suffice.

FIG. 1 shows the usual two flexible couplings and mid-shaft arrangement that transmits torque from a motor rotor to the motor output shaft. Mid-shaft 1 may be intrinsic with ends 2 and 4. Some arrangements threadedly connect parts 2 and 4 to the mid-shaft 1. The coupling description herein will relate to one coupling (FIG. 2) with a threaded adjunct that can be made part of a device such as FIG. 1.

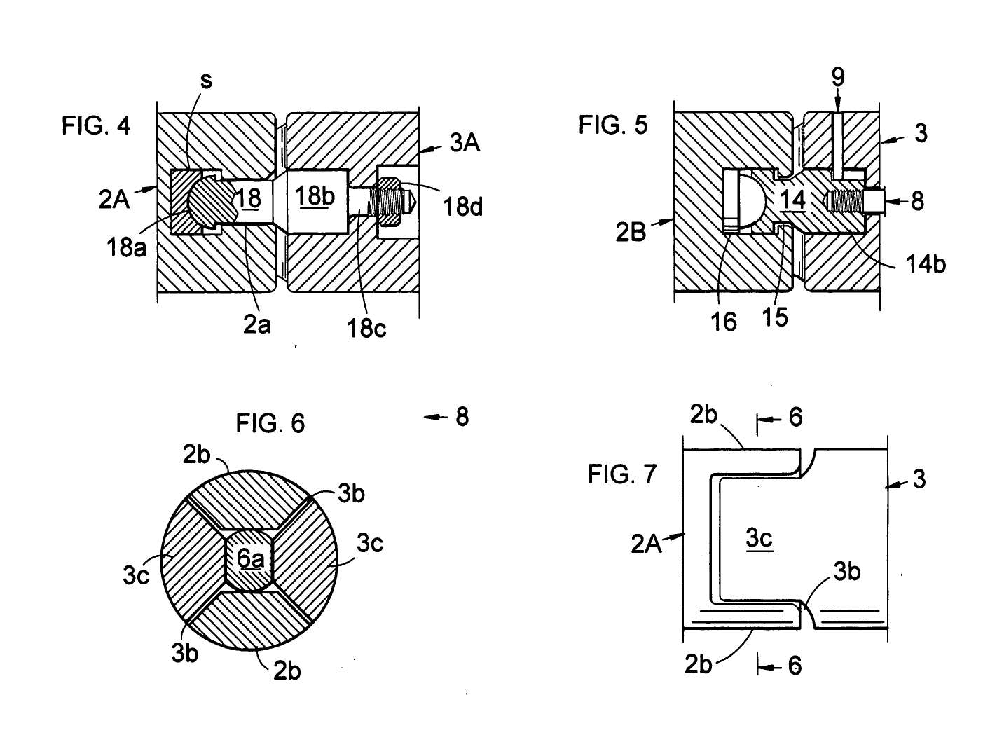

As shown in FIG. 1, pin 9 could be used to prevent the compression unit 6 from rotating in portion 3 due to tightening the cap screw 8 if some forms of the coupling are used. The preferred jaw coupling (FIGS. 2 and 4) will not allow the compression unit to rotate. Note in FIG. 6 that the compression unit ball end is flattened on two sides and is rotationally trapped by jaws 3c. In that, preferred, configuration the compression unit needs no pin such as 9.

FIG. 2 is shown with tool joints on both ends as it is sometimes used. The left end is now captioned 2A. Compression unit 6, the preferred form of compression unit, involves a ball 6a and base 6b. The socket s arrangement can be an insert or a spherical surface machined into the portion 2A. In the preferred jaw coupling, the compression unit can be inserted into bore 2a in a direction transverse to the axis of the coupling when jaw 3c (see FIG. 6) is not in place. Bore 2a axially traps the partial ball end of the compression unit in portion 2A. The base 6b of the compression unit is secured to portion 3. If the base 6b is very secure in portion 3, the coupling cannot be pulled apart axially unless the pull forces destroy the ball end 6a, and it is a robust component of the coupling. The tension link 8 is shown as a cap screw that can carry substantial axial forces.

FIG. 3 shows a prior art coupling that has been used for several years and has proved the compression unit competence. As a tension load carrying unit, the shear pins PIN have limited ability to carry tension forces. The risk of losing the lower portion of the drill string because of shear pin limits does exist. Strengthening the PINs and extending them through base 10 weakens the base 10. A better tension carrying ability is needed.

FIG. 4 shows an alternate form of the tension link. The compression unit 18 has partial sphere 18a captured in portion 2A. The base 18b has extension 18c extending into the portion now captioned 3A and it is secured by a nut 18d. The nut could be replaced by such as a snap ring or the equivalent. Partial ball 18a is entrapped by bore 2a.

FIG. 5 shows an alternate positioning of the spherical surfaces. Portion 2B is somewhat changed to receive the convex portion 16 mating the concave spherical part of the compression unit 14. Bore 15 confines the compression unit 14 in portion 2B. Tension link 8 secures the compression unit 14 in portion 3. Pin 9, if needed, is used to prevent rotation of 14b when the (tension link) screw 8 is tightened.

FIG. 6 is a section taken along line 6-6 and shows ball 6a rotationally captured by the jaws 3c.

FIG. 7 is a side view of the jaw portion of the coupling. Clearance 3b runs endlessly about the periphery of the portions interface and permits torque to be conducted along intersecting axes of rotation. Jaws 2b and 3c are typical of four jaw couplings.

From the foregoing, it will be seen that this invention is one well adapted to attain all of the ends and objects hereinabove set forth, together with other advantages which are obvious and which are inherent to the flexible coupling.

It will be understood that certain features and sub-combinations are of utility and may be employed without reference to other features and sub-combinations. This is contemplated by and is within the scope of the claims.

As many possible embodiments may be made of the apparatus of this invention without departing from the scope thereof, it is to be understood that all matter herein set forth or shown in the accompanying drawings is to be interpreted as illustrative and not in a limiting sense.

The invention having been described, We claim:

1. An improved coupling assembly for connecting, as an axially serial continuation, a down hole motor rotor to the down hole motor output shaft, the improved coupling assembly comprising:
a) a first flexible coupling portion arranged for connection at a first end to the motor rotor and arranged, at a second end, for rotational connection to a second flexible coupling portion;
b) said second flexible coupling portion arranged for connection, at a third end, to the motor output shaft, and arranged at a fourth end to receive said rotational connection;
c) a compression unit secured to one said flexible coupling portion and extending into the other said flexible coupling portion; and
d) a tension link arranged to engage said compression unit, and secured to said other flexible coupling portion.

2. The coupling assembly of claim 1 wherein said tension link is a cap screw.

3. The coupling assembly of claim 1 wherein said coupling portions are jaw type with interdigitating jaws.

4. The coupling assembly of claim 3 wherein said jaws comprise two jaws on each said flexible portion.

5. The coupling assembly of claim 3 wherein said jaws consist of a plurality of jaws on each said flexible portion.

6. The coupling assembly of claim 1 wherein said tension link is an extension of said compression unit.

7. An improved down hole motor flexible coupling for use as an axially serial coupling between the down hole motor rotor and the output shaft of the down hole motor, the flexible coupling comprising:
a) a first coupling portion, having a first axis, with first abutment surfaces arranged to deliver rotational force about said first axis;
b) a second coupling portion, having a second axis, with second abutment surfaces to deliver rotational forces to the first abutment surfaces to transmit torque along the axes which can flex but are mutual extensions;
c) a compression unit secured to one of said coupling portions and extending into the other said coupling portion, situated to carry compressive loads tending to thrust said two portions together, said compression unit axially entrapped in one said portions and secured in the other said portion by a tension element; and
d) said tension element secured to said compression unit and arranged to secure said compression unit in said other coupling portion.

8. The down hole motor flexible coupling according to claim 7 wherein said tension element is a cap screw.

9. The down hole motor flexible coupling according to claim 7 wherein said tension link is, in part, an extension of said compression unit.

10. The coupling assembly of claim 3 wherein said jaws consist of a plurality of jaws on each said flexible coupling portion.
